(19) United States
(12) Patent Application Publication
(10) Pub. No.: US 2026/0040094 A1
(43) Pub. Date: Feb. 5, 2026

(54) Hierarchical Graph Representation for Network Management

(71) Applicant: Dell Products L.P., Round Rock, TX (US)

(72) Inventors: Javad Mirzaei, Toronto (CA); Jeebak Mitra, Ottawa (CA); Gwenael Poitau, Montreal (CA)

(21) Appl. No.: 18/795,097

(22) Filed: Aug. 5, 2024

(51) Int. Cl. H04W 24/02; H04L 41/16

(52) U.S. Cl. CPC H04W 24/02; H04L 41/16

(57) ABSTRACT

A system can produce a first graph that represents components of a broadband cellular network, wherein the first graph comprises first nodes and first edges. The system can process the first graph with a graph neural network to produce a feature embedding matrix. The system can pool information of nodes of the first graph based on the feature embedding matrix, to produce a second graph, wherein the second graph comprises second nodes and second edges. The system can adjust a parameter of a network controller of the broadband cellular network based on the second graph.

### BACKGROUND

Broadband cellular networks can facilitate network communications with user equipment (UE).

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can produce a first graph that represents components of a broadband cellular network, wherein the first graph comprises first nodes and first edges. The system can process the first graph with a graph neural network to produce a feature embedding matrix. The system can pool information of nodes of the first graph based on the feature embedding matrix, to produce a second graph, wherein the second graph comprises second nodes and second edges. The system can adjust a parameter of a network controller of the broadband cellular network based on the second graph.

An example method can comprise generating, by a system comprising at least one processor, a first graph that represents components of a broadband cellular network. The method can further comprise processing, by the system, the first graph with a graph neural network to generate a feature embedding matrix. The method can further comprise pooling, by the system, information of nodes of the first graph based on the feature embedding matrix, to generate a second graph. The method can further comprise adjusting, by the system, a parameter of a network controller of the broadband cellular network based on the second graph.

An example non-transitory computer-readable medium can comprise instructions that, in response to execution, cause a system comprising a processor to perform operations. These operations can comprise processing the graph that represents components of a broadband cellular network with a graph neural network to create a feature embedding matrix. These operations can further comprise pooling information of nodes of a first graph based on the feature embedding matrix, to create a second graph. These operations can further comprise adjusting a parameter of a network controller of the broadband cellular network based on the second graph.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that is facilitated by hierarchical graph representation for network management, in accordance with an embodiment of this disclosure;

FIG. 2 illustrates another example system architecture, in accordance with an embodiment of this disclosure;

FIG. 3 illustrates an example graph that is facilitated by hierarchical graph representation for network management, in accordance with an embodiment of this disclosure;

FIG. 4 illustrates another example graph that is facilitated by hierarchical graph representation for network management, in accordance with an embodiment of this disclosure;

FIG. 5 illustrates another example graph that is facilitated by hierarchical graph representation for network management, in accordance with an embodiment of this disclosure;

FIG. 6 illustrates another example graph that is facilitated by hierarchical graph representation for network management, in accordance with an embodiment of this disclosure;

FIG. 7 illustrates an example mapping between a graph and a hierarchy of a broadband cellular network, and that is facilitated by hierarchical graph representation for network management, in accordance with an embodiment of this disclosure;

FIG. 8 illustrates an example of a hierarchy in a federated learning process that is facilitated by hierarchical graph representation for network management, in accordance with an embodiment of this disclosure;

FIG. 9 illustrates an example of inter-cluster transfer learning that is facilitated by hierarchical graph representation for network management, in accordance with an embodiment of this disclosure;

FIG. 10 illustrates an example process flow that is facilitated by hierarchical graph representation for network management, in accordance with an embodiment of this disclosure;

FIG. 11 illustrates another example process flow that is facilitated by hierarchical graph representation for network management, in accordance with an embodiment of this disclosure;

FIG. 12 illustrates another example process flow that is facilitated by hierarchical graph representation for network management, in accordance with an embodiment of this disclosure;

FIG. 13 illustrates an example block diagram of a computer operable to execute an embodiment of this disclosure.

### DETAILED DESCRIPTION

### Overview

While the examples herein generally relate to an open radio access network (O-RAN), it can be appreciated that the present techniques can be generally applicable to scenarios where a network controller has a hierarchical relationship in terms of generation and consumption of network-specific data and actuation of network control policies through a combination of centralized (super-graph) and distributed control (sub-graph).

Broadband cellular networks have evolved in a way that operational optimization of the network now generally does not occur by considering a cell site in isolation, but involves consideration of the correlated impact of a cluster of cells that are adjacent to each other. To address such use issues, intelligent network controllers (such as the radio access network (RAN) intelligent controllers (RICs) in case of an O-RAN) can be utilized for optimizing network behavior in a data-driven fashion. However, where network operational state keeps evolving with traffic demand and user mobility, achieving an optimal network state in terms of resource usage, as well as ensuring meeting all network key performance indicators (KPIs) can be a complex problem that can have several intricate dependencies that become hard to model using prior approaches.

The present techniques can facilitate network optimization with multiple dependencies. This can be a complex problem to address, as modeling the dependencies and evaluating the impact of optimization on the other can become time-consuming, and therefore pursuing exhaustive approaches can be burdensome. At the same time, network automation and self-optimization that is scalable can be an objective for network operators, as the deployment and operational costs of networks grow. In open networks in particular, a concept of a central entity that can be referred to as “intelligent network controller” (e.g., a RIC in a context of some cellular networks), and has a better visibility of the entire network than individual base stations, can be emerging, but lack enough details on its use and implementation for network-wide optimization.

The present techniques can be implemented to provide a scalable and network-topology agnostic user association technique using graphical abstraction, and computationally efficient optimization, using graph neural networks (GNN). The present techniques can be implemented to incorporate a multi-tier controller in a multi-level graphical abstraction, such that each layer can carry out a network optimization function independently by using the layer below as a feeder network for relevant network measurements. The present techniques can be implemented to exchange telemetry and policy decisions within a layer and amongst multiple layers for enabling decision-making and actuation of data-driven network wide policy control.

The present techniques can be implemented to use the graphs described herein to gather information. Graphs can be agnostic to the topology of a network. Graphs can be scalable for real and large networks. Graphs can be generalizable due to being topology agnostic; they can adapt to various network topologies/configurations. Graphs can require less training data than other techniques (which can be beneficial in a wireless application where real data can be scarce). A heterogenicity of a network (e.g., due to different capabilities of network elements, such as a radio unit) can be naturally captured using graphs.

Broadband cellular networks can be complex. Fifth generation (5G) and beyond 5G (B5G) networks can usher in several advanced features for the user, including ultra-high speeds, low-latency modes for augmented reality/virtual reality (AR/VR) scenarios, autonomous driving, and connectivity for hundreds of devices through various modes. Implementation of such advanced features can come with a high complexity of network operations.

With various control loops that exist to ensure smooth functioning of various network modules, a tremendous amount of data can be generated that can be harnessed to determine trends in network behavior that can be used for a multitude of purposes, including an improvement of network resource allocation or to anticipate capacity crunches in the network (combining it with geospatial data, for example).

There can be a trend toward disaggregated networks. There can be a trend and momentum towards uses of well-defined open interfaces between network layers, so as to use the information and control message exchange through these interfaces in combination with virtualization of key network functions to amortize the computational and deployment cost of networks by using commoditized hardware to implement telecom networks and bring in the intelligence in network control in a more democratized fashion where multiple entities can contribute through primarily data-driven optimization software.

An O-RAN framework can allow for a disaggregation of legacy base station functionalities, whereby the BS modules can be implemented across multiple RAN modules/nodes with the interfaces between different modules being open and standardized for interoperability.

With a software-based approach to enable algorithmic and programmatic control to dynamically configure the network based on a current network status, RAN Intelligent Controllers (RICs) can host multiple applications to perform closed-loop control of the RAN, using artificial intelligence (AI) and machine learning (ML) techniques.

Data-driven solutions at the RIC can leverage a broader view of the network to learn complex inter-dependencies between RAN parameters and help design policies for what can be relatively disparate Quality of Service (QOS) requirements of each user equipment (UE).

However, decisions can also be made at the distributed unit (DU) for level 2 (L2) and level 3 (L3) functionality, while the Radio unit (RU) can play a role in collecting key operational data and being a point of contact for the UEs the network (that is, the radio can process signals and transform them from digital to a form that travels as electromagnetic waves to UEs). With multiple control loops running at different time-scales and different levels of the network, an integrated modeling approach for the entire network can be desirable.

In prior approaches, network optimization in current networks can primarily be rules-based, and typically optimize for a single metric, while using deterministic thresholds for other KPIs to ensure that the network operates within those tolerance bands. However, this approach can be becoming increasingly deficient in terms of coping with myriad dependencies among KPIs, and network policies that can provide conflicting goals in terms of parameter adaptation.

An indication of network performance can be obtained using various network diagnostics and health data that is generated as part of a protocol requirement, or on-equipment telemetry in network entities.

Additionally, rules based approaches can be able to capture only localized elements of a problem, and be unable to take advantage of historical cell state, or take a global view of the network state. Even for data-driven approaches, it can be that techniques based on supervised ML can perform poorly when a network topology changes, or network behavior is different from that assumed for a training period.

Therefore, methods that can assimilate measurements and data obtained in the field to update the model characteristics for network optimization can be desirable. Graph-based optimization can lend itself to a model of modern networks can be applied to network optimization problems such as resource allocation, and/or user re-association for load balancing or energy efficiency improvement, and to devise scalable network algorithms.

However, with an emerging architecture of disaggregated networks controlled at multiple levels and with control policies that are activated for multiple time scales (e.g., near-and non-real time (RT) RICs in O-RAN), there can be a need to devise approaches for network optimization using non-flat graphical structures that can leverage curated data from a layer below.

Graph neural networks (GNNs) have been applied to various problems in wireless communications, as they can lend themselves to capturing dependencies within a network, and the use of a neural network (NN) can allow for modeling of arbitrary distributions that do not have definite analytical representation. When applying GNNs to network optimization/resource management in a network with multi-level control (e.g., an O-RAN), one approach can be to generate embeddings for all the nodes in the graph, and then to globally assimilate all these node embeddings, e.g., using a simple summation or NN that operates over a planar graph.

This global collection approach can ignore a hierarchical structure that may inherently be present in the network, and it can prevent building GNN models that are effective for different tasks over the entire graph, across multiple levels that can inherently exist.

In an O-RAN, for example, the execution of xApps/rApps at the near/non real-time RIC can incur a large data communication overhead, since the node-level information can need to be communicated all the way to the RIC (from the telemetry points) for graph processing. This can be challenging when dealing with a heterogenous and large-scale RAN, where real-time data flow and delay constraints are not satisfied.

Moreover, a lack of hierarchical structure in a flat GNN can be problematic for network level tasks, where a goal can be to manage resources while respecting the constraints across an entire network. Therefore, with a flat graph representation, it can be that it is not possible to learn the network structure, and infer in a way that is structurally similar to the actual network operation.

The present techniques can facilitate a generic way to represent multi-level network optimization architectures in the form of graphical abstraction, and subsequently using deep neural networks (DNNs) to model relationships between the nodes and derive optimal configurations.

The present techniques can further facilitate pooling information from lower layers that can operate at a different timescale for upper layers that can further operate on data from multiple sub-graphs to make an optimization decision (that is, a global optimization objective, as compared to a local optimization made at a sub-graph) and relay that to the lower sub-graphs for execution.

The present techniques can facilitate using a super graph that can play a role of a collection of centralized nodes as done through a global model in the case of federated learning. The present techniques can facilitate using information transfer between nodes that are not fully connected, but can have spatial and/or semantic correlation to leverage transfer learning with domain adaptation over a graph structure to reduce learning time for greenfield networks.

The present techniques can be applied to a disaggregated network architecture (e.g. an O-RAN framework), whereby messages passed across standardized interfaces can be mapped to information passed along the edges of a hierarchical graph.

The present techniques can facilitate a way to represent a multi-level controller architecture that is being increasingly-adopted for modern wireless networks using unique graphical abstractions.

The present techniques can facilitate using an array of AI/ML tools in a domain of GNNs to provide a scalable optimization solution for networks of any size.

The present techniques can facilitate obtaining a network topology and obtaining an optimized solution (in the form of connectivity matrix or optimal network parameters) to incorporate multi-level graph processing to account for the interaction of multiple parts of the network.

Prior approaches lack an implementation of GNNs for solving network optimization for large scale wireless cellular networks with disaggregated multi-level control.

In contrast, the present techniques can facilitate mapping network elements, and deriving a solution procedure after providing techniques for incorporating key modeling and optimization objectives into a graphical representation.

### Example Architectures, Graphs, Etc.

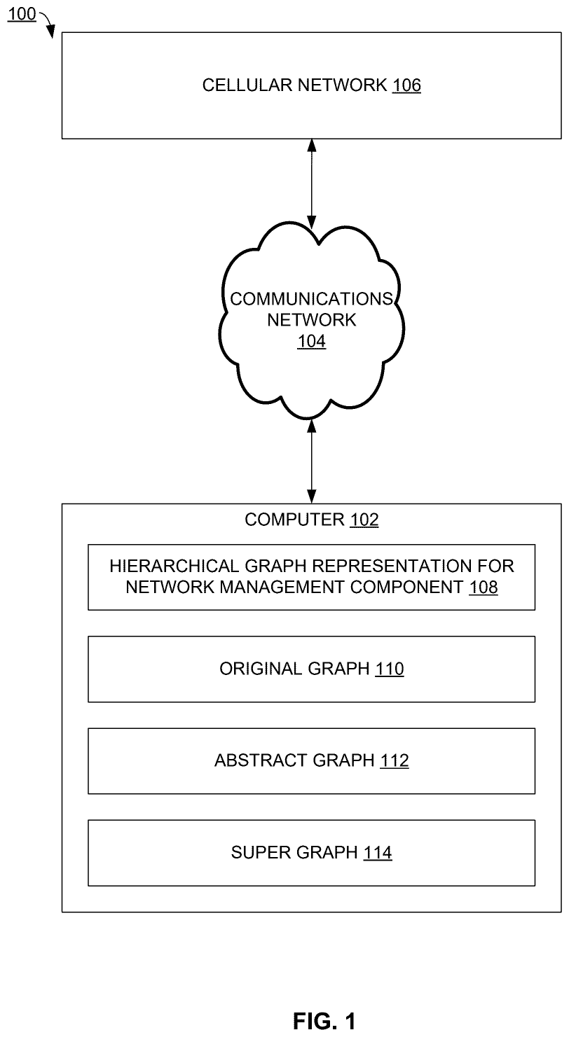

FIG. 1 illustrates an example system architecture 100 that is facilitated by hierarchical graph representation for network management, in accordance with an embodiment of this disclosure.

System architecture 100 comprises computer 102, communications network 104, cellular network 106, hierarchical graph representation for network management component 108, original graph 110, abstract graph 112, and super graph 114.

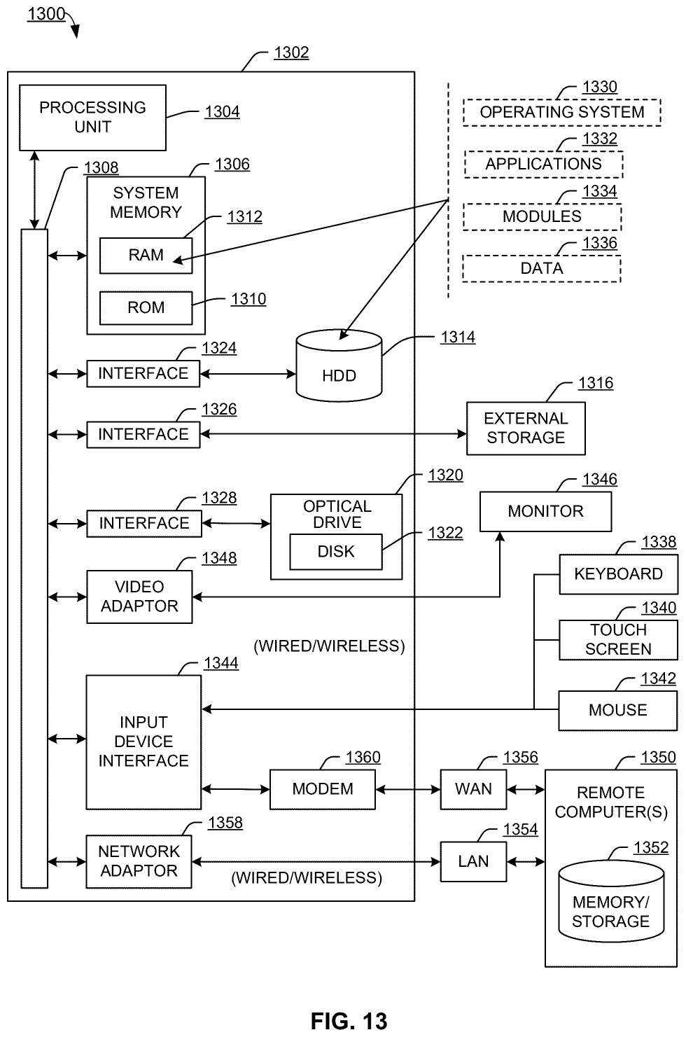

Each of computer 102 and/or cellular network 106 can be implemented with part(s) of computing environment 1300 of FIG. 13. Communications network 104 can comprise a computer communications network, such as the Internet, or an isolated private computer communications network.

Cellular network 106 can comprise a broadband cellular network that facilitates broadband communications with user equipment (UE).

Hierarchical graph representation for network management component 108 can model cellular network with multiple layers of abstraction, e.g., original graph 110, abstract graph 112, and super graph 114. Hierarchical graph representation for network management component 108 can use information from original graph 110, abstract graph 112, and super graph 114 to control operation of cellular network 106.

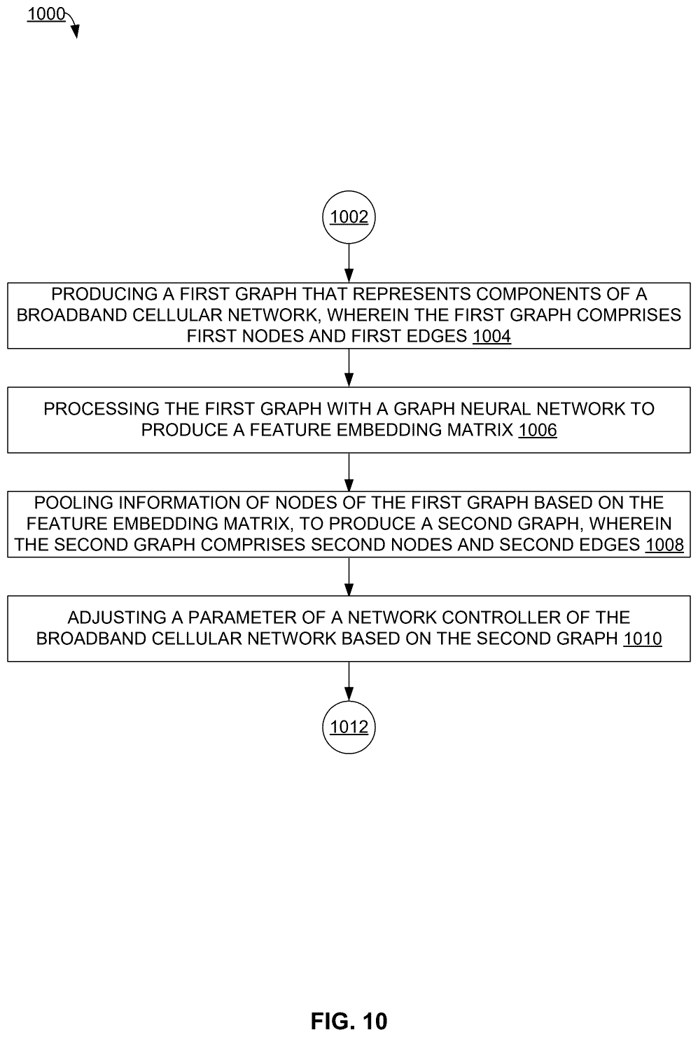

In some examples, hierarchical graph representation for network management component 108 can implement part(s) of the process flows of FIGS. 10-12 that is facilitated by hierarchical graph representation for network management.

It can be appreciated that system architecture 100 is one example system architecture for hierarchical graph representation for network management, and that there can be other system architectures that facilitate hierarchical graph representation for network management.

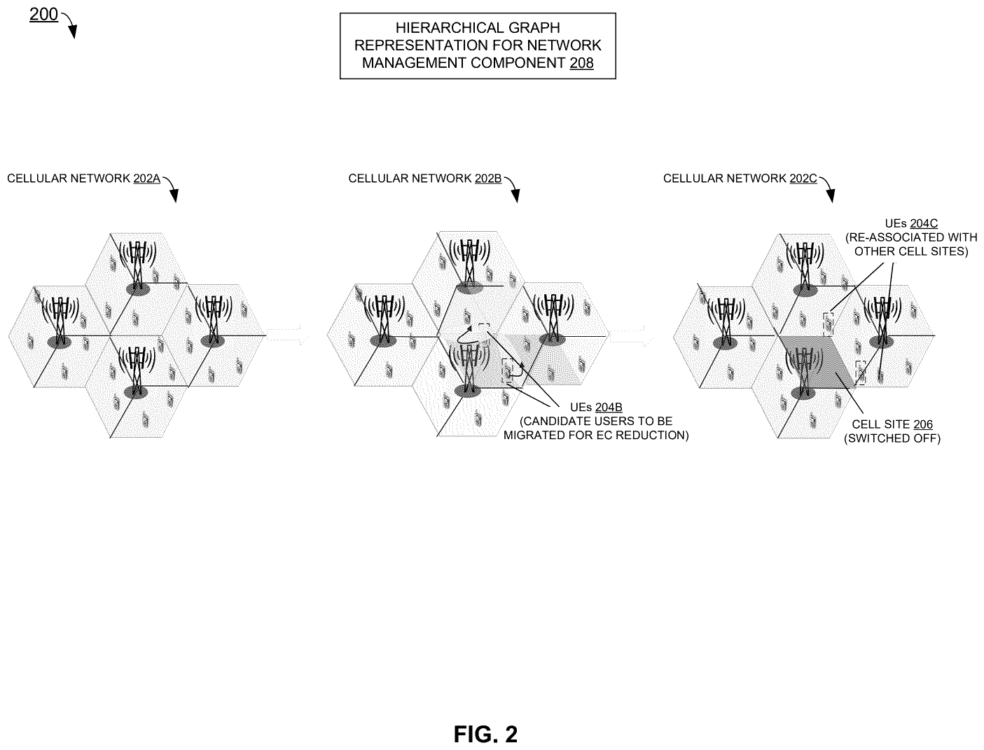

FIG. 2 illustrates another example system architecture 200, in accordance with an embodiment of this disclosure. In some examples, part(s) of system architecture 200 can be used by part(s) of system architecture 100 of FIG. 1 that is facilitated by hierarchical graph representation for network management.

System architecture 200 comprises cellular network 202A, cellular network 202B, cellular network 202C, UEs 204B (candidate users to be migrated for EC reduction), UEs 204C (re-associated with other cell sites), cell site 206 (switched off), and hierarchical graph representation for network management component 208 (which can be similar to hierarchical graph representation for network management component 108 of FIG. 1).

Cellular network 202A, cellular network 202B, cellular network 202C depict the same cellular network at different points in time. Relative to cellular network 202A, in cellular network 202B, a decision has been made to migrate UEs 204 so that a cell site can be switched off In cellular network 202C, cell site 206 is now switched off, and UEs 204C are UEs 204B after being migrated.

System architecture 200 can depict a problem encountered in network operations to optimize an energy consumption metric, which can be achieved by switching off some cell sites that have low traffic volume to reduce a global energy consumption metric.

In an example cellular network, each cell can generally have a tri-selector antenna that covers 120 degrees and is part of a “cluster” of cells that (a) have some overlap of coverage area and (b) can influence traffic characteristics (and therefore resource usage) of each other. These can be behavioral correlations that can be modeled using a graph structure.

From cellular network 202A to cellular network 202B, a cell site is identified for switching off, and UEs anchored on that cell can be candidates for migration to neighboring cell sites. This can be a rearrangement of graph relations.

Cellular network 202C shows the UE re-associated with a different cell site, and the candidate cell site switched off to reduce energy consumption (and with reduced coverage). This can correspond to an updated graph topology with scale up and scale down capability.

With regard to the present techniques, these actions can be decided upon by a policy module within a near-RT (e.g., hierarchical graph representation for network management component 208) independently or through explicit support from a global policy module in a non-RT RIC.

The present techniques can be implemented such that they are facilitated by a hierarchical graph module that can be adapted to various GNN architectures for an end-to-end multi-level network control. This approach can facilitate developing deeper GNN models that can learn to operate on hierarchical representations of a graph. Operationally, a graph structure according to the present techniques can be derived from the spatial pooling operation in convolutional neural networks (CNN), for example, which can allow an iterative operation on progressively coarser representations of an image.

A challenge in a GNN setting can be two-fold (compared to standard CNNs):

It can be that graphs contain no natural notion of spatial locality (that is, it can be that one cannot simply pool together all nodes in a “m×m patch” on a graph), because a complex topological structure of graphs can preclude any straightforward, deterministic definition of a “patch”.

Unlike image data, it can be that graph datasets often contain graphs with varying numbers of nodes and edges, which can make defining a general graph pooling operator even more challenging.

In order to solve these challenges, the present techniques can facilitate a hierarchical graph model that learns how to pool the nodes' information to build a hierarchical multi-layer graphs on top of an underlying graph.

This approach can be based on a differentiable and permutationally invariant pooling operation at each layer of a deep GNN, and mapping nodes to a set of clusters based on their learned embeddings. By “stacking” GNN layers in a hierarchical fashion, the input nodes at each layer of GNN module can correspond to a virtual node learned at the previous layer of GNN module. Indeed, each layer can coarsen the input graph more and more, so a hierarchical representation of any input graph can be generated after training.

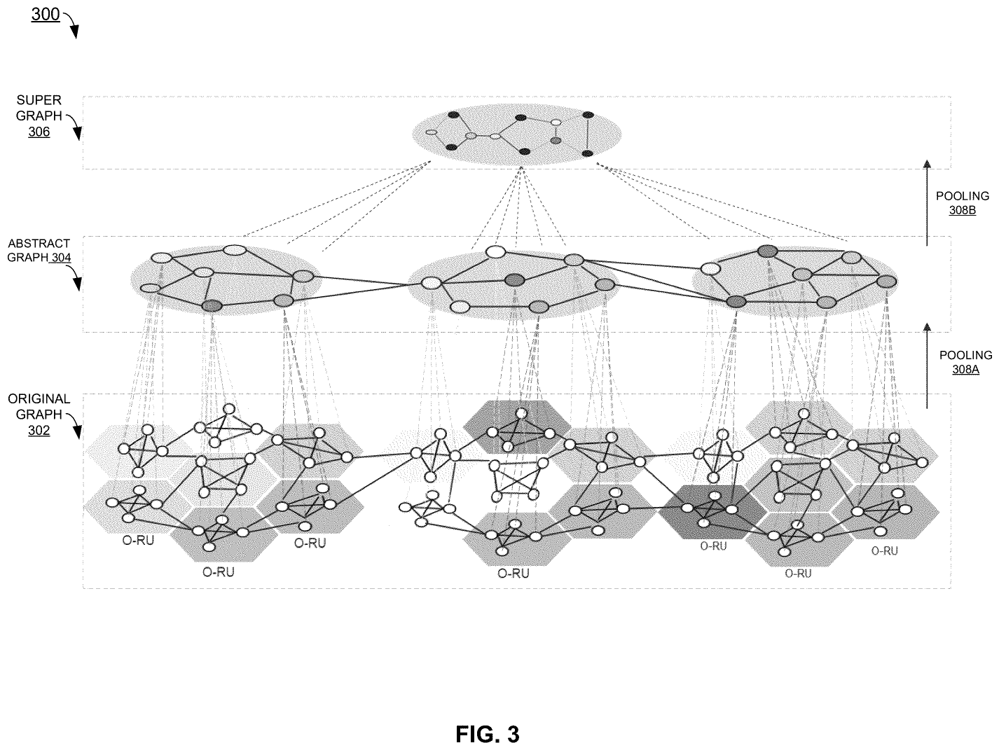

FIG. 3 illustrates an example graph 300 that is facilitated by hierarchical graph representation for network management, in accordance with an embodiment of this disclosure. In some examples, part(s) of graph 300 can be used by part(s) of system architecture 100 of FIG. 1 that is facilitated by hierarchical graph representation for network management.

Graph 300 comprises original graph 302, abstract graph 304, super graph 306, pooling 308A, and pooling 308B.

The present techniques can be used to implement an architecture that comprises multiple layers of graphs that stacked in a hierarchical fashion Unlike the flat graphs, this architecture can facilitate learning a hierarchical structure of a network, which can inherently exist in wireless networks.

Constructing such a hierarchical GNN architecture can be based on pooling information from one level to the next one. In particular, the GNN can map nodes to a set of clusters, which can then form the super nodes at the higher levels of the network. The abstracted graphs at the higher levels can be a coarser version of the nodes in the lower levels.

Topological information of an underlying original graph can be captured into upper graphs via a differentiable and permutation invariant pooling process.

Using such hierarchical GNN architecture, decision-making at the higher levels (e.g., at a RIC) can consider a hierarchical structure of the real-world physical network, in contrast to prior approaches.

Such structure can facilitate defining objectives at the RIC level while controlling the network components at the RU level.

An example hierarchical structure according to the present techniques can have the following components:
The original graph;
The abstract graph;
The super graph;
The pooling operation between each layer.

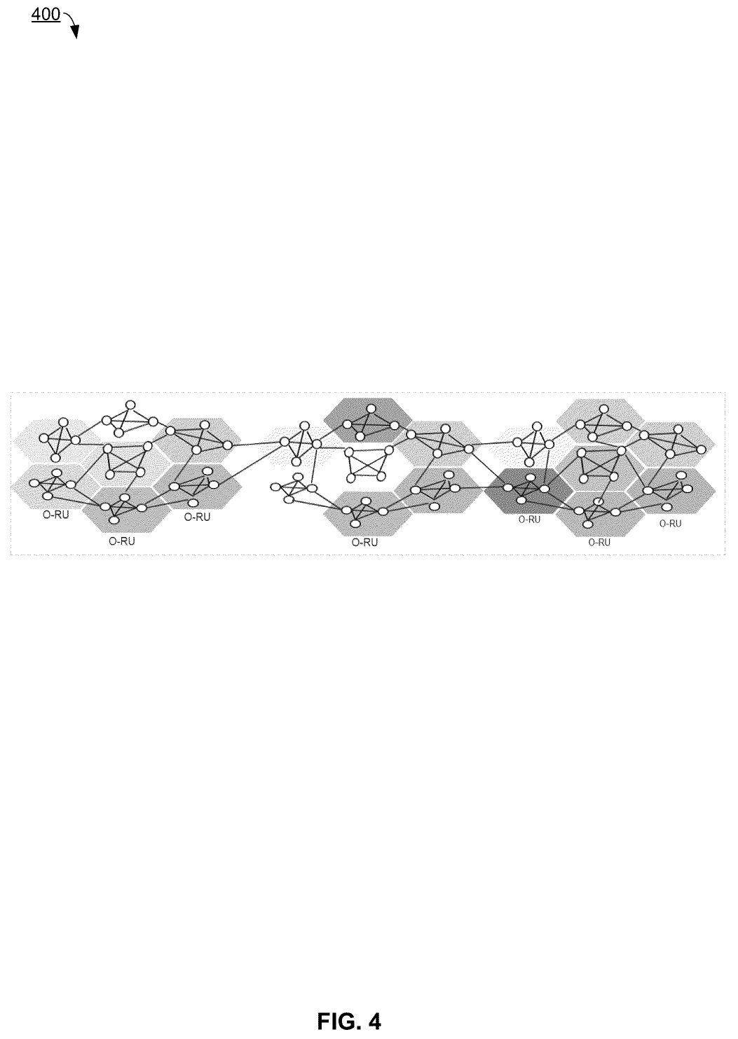

FIG. 4 illustrates another example graph 400 that is facilitated by hierarchical graph representation for network management, in accordance with an embodiment of this disclosure. In some examples, part(s) of graph 400 can be used by part(s) of system architecture 100 of FIG. 1 that is facilitated by hierarchical graph representation for network management.

Graph 400 depicts an original graph, similar to original graph 302 of FIG. 3.

At the lower level, the original graph can be defined as G^{o}(V^{o},E^{o}), where V^{o} is the set of vertices and E^{o} is the set of edges connecting the vertices in Vo. It can be assumed that G^{o} has n nodes, where each node has d features. X^{o} and A^{o} denote the feature matrix and adjacency matrix of the original graph respectively.

After k^{o} iterations of standard GNN processing, Z^{o}, the feature embedding matrix of this original graph can be obtained. Z^{o}can then be used to:
Construct the features of the abstract graph;
Perform local decision making at the RU level (edge).

$$That is , {Z}^{o} = {GNN}^{o} ( {A}^{o} , {X}^{o} )$$

where,
Z^{o}∈R^{n×p} is the nodes' embedding matrix
A^{o}∈{0,1]^{n×m} is the adjacency matrix
X^{o}∈R^{n×d} is the nodes' feature matrix.

A pooling operation from the original graph to the abstract graph can be based on the matrix S^{o}={0,1}^{n×c}, which defines the association of each node in original graph to one of the c clusters.

Note that the matrix So can be predefined based on the cell/cluster association. Alternatively, it can be calculated using a softmax operation over Z^{o} as:

S^{o}=Softmax(Z^{o})

Once S^{o} is obtained, the abstract graph in the next layer can be constructed using a mapping function P^{a}(⋅):

$$( {X}^{a} , {A}^{a} ) = {P}^{a} ( {X}^{o} , {A}^{o} ; {S}^{o} )$$

P^{a}(⋅) can be chosen to have permutationally invariant operations and differentiable with respect to its parameters.

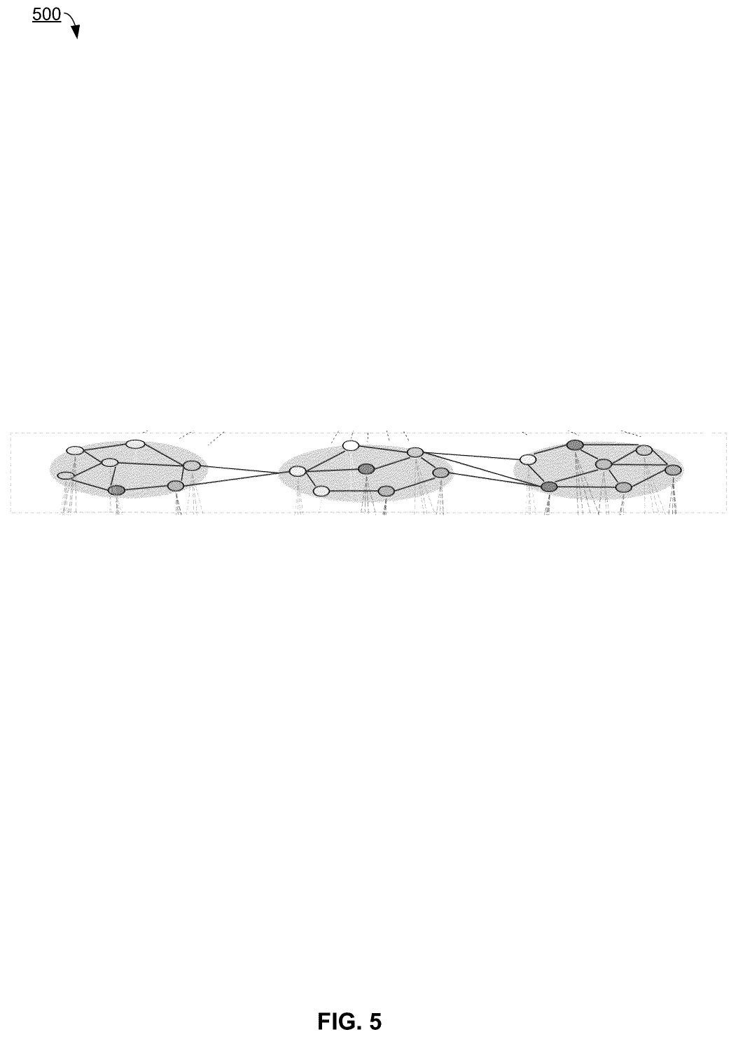

FIG. 5 illustrates another example graph 500 that is facilitated by hierarchical graph representation for network management, in accordance with an embodiment of this disclosure. In some examples, part(s) of graph 500 can be used by part(s) of system architecture 100 of FIG. 1 that is facilitated by hierarchical graph representation for network management.

Graph 500 depicts an abstract graph, similar to abstract graph 304 of FIG. 3.

The abstract graph can be constructed using the “pooled” features of the original graph

At a higher level, the abstract graph can be defined as G^{a}(V^{a},E^{a}), where V^{a} is the set of vertices and E^{a} is the set edges connecting the vertices in V^{a}.

The nodes in V^{a} can comprise a virtual representation of the collection of nodes in V^{a}. Similarly, the entries of E^{a} represent the connection between the nodes in Va.

After k^{a} iterations of GNN processing, Z^{a} can be obtained, which is the nodes' embeddings of the abstract graph.
Z^{a} can then be used to:
Construct the features of a super graph at the higher level;
Perform local decision making at the RIC level.

Note that the abstract graph could be a heterogenous graph to accommodate different nodes and edge types when constructing the abstract graph from the underlying original graph.

A pooling operation from the abstract graph to the super graph can be based on the matrix S^{a}={0,1}^{c×l}, which defines the association of each node in abstract graph to one of the l clusters.

Note that the matrix S^{a} can be calculated using a softmax operation over Z^{a} as:

$${S}^{a} = Softmax ( {Z}^{a} ) .$$

Once S^{a} is obtained, the super graph in the next layer can be constructed using a mapping function P^{s}(⋅):

$$( {X}^{s} , {A}^{s} ) = {P}^{s} ( {X}^{a} , {A}^{a} ; {S}^{a} ) .$$

P^{s}(⋅) can be chosen to have permutationally invariant operations and differentiable with respect to its parameters.

In constructing an abstract graph,

$${Z}^{a} = {GNN}^{a} ( {A}^{a} , {X}^{a} )$$

where,
Z^{a}∈R^{c×q} is the abstract nodes' embedding matrix
A^{a}∈R^{c×c} is the adjacency matrix
X^{a}∈R^{c×p} is the abstract nodes' feature matrix.

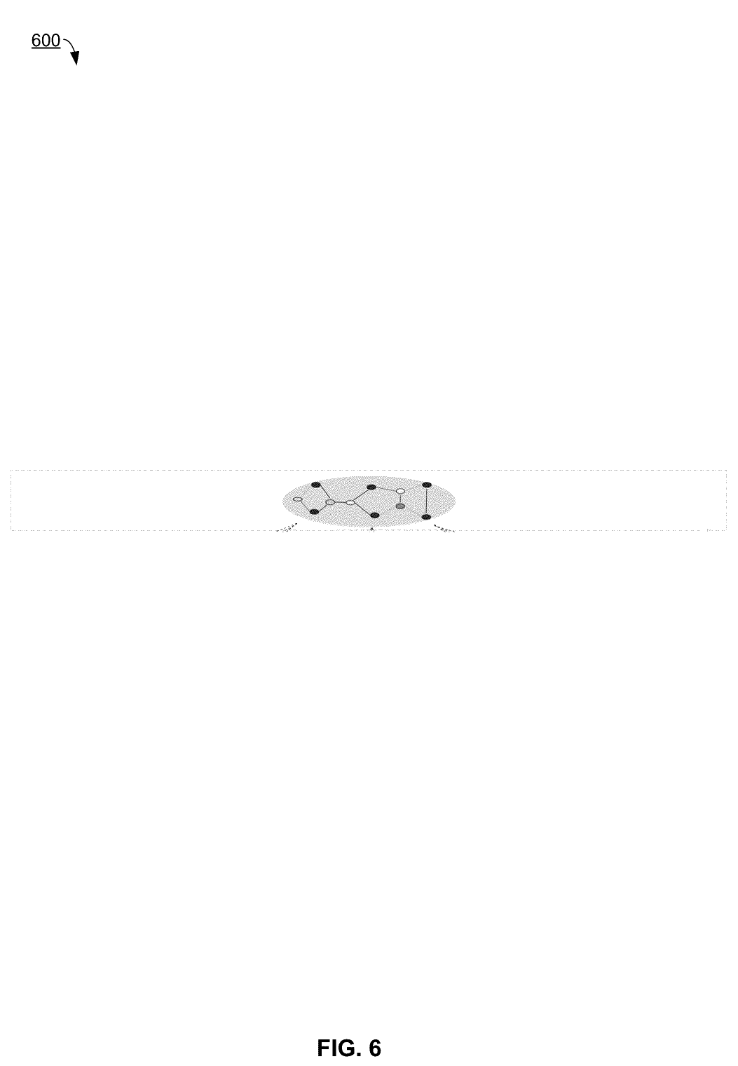

FIG. 6 illustrates another example graph 600 that is facilitated by hierarchical graph representation for network management, in accordance with an embodiment of this disclosure. In some examples, part(s) of graph 600 can be used by part(s) of system architecture 100 of FIG. 1 that is facilitated by hierarchical graph representation for network management.

Graph 600 depicts a super graph, similar to super graph 306 of FIG. 3.

The nodes in the super graph can be represented by a feature vector obtained from the underlying abstract and original graphs at the radio unit (RU) level. At the highest level, the super graph can be defined as G^{s}(V^{s},E^{s}), where V^{s} is the set of vertices and E^{s} is the set edges connecting the vertices in V^{s}.

The nodes in V^{s}can comprise a virtual representation of the collection of nodes in V^{s}. Similarly, the entries of E^{s}can represent the connection between the super nodes in V^{s}.

After k^{s}iterations of GNN processing, Z^{s}can be obtained, which represents the nodes' embeddings at the RIC level. Z^{s}can then be used for a high-level network wide decision making

Similar to the abstract graph, the constructed graph at this level can be a heterogenous graph to accommodate different nodes and edge types when constructing the super graph from the underlying graph.

In constructing a super graph,

$${Z}^{s} = {GNN}^{s} ( {A}^{s} , {X}^{s} )$$

where,
Z^{s}∈R^{l×m} is the super nodes' embedding matrix
A^{s}∈R^{l×l} is the adjacency matrix
X^{s}∈R^{l×q} is the super nodes' feature matrix.

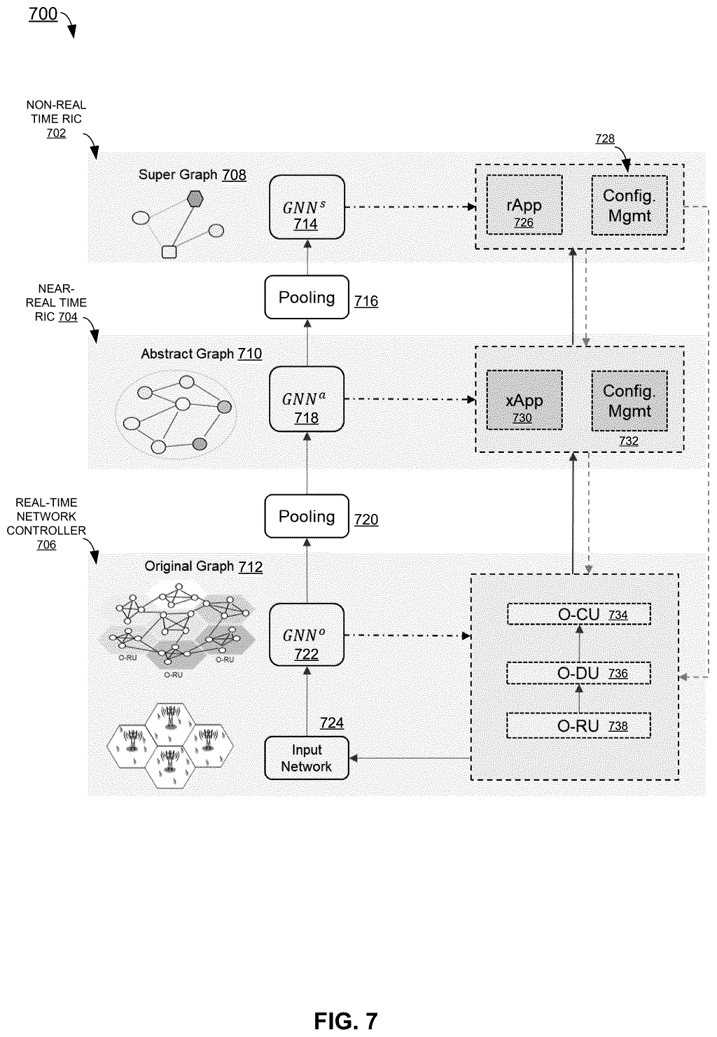

FIG. 7 illustrates an example mapping 700 between a graph and a broadband cellular network, and that is facilitated by hierarchical graph representation for network management, in accordance with an embodiment of this disclosure. In some examples, part(s) of mapping 700 can be used by part(s) of system architecture 100 of FIG. 1 that is facilitated by hierarchical graph representation for network management.

Mapping 700 comprises non-real time RIC 702, near-real time RIC 704, real-time network controller 706, super graph 708, abstract graph 710, original graph 712, GNN^{s} 714, pooling 716, GNN^{a} 718, pooling 720, GNN^{o} 722, input network 724, rApp 726, configuration management 728, xApp 730, configuration management 732, O-RAN CU (O-CU) 734, O-RAN DU (O-DU) 736, and O-RAN RU (O-RU) 738.

At a non-RT RIC, the abstract graph can be coarsened to construct a heterogenous super graph via a differentiable and permutation invariant pooling. The nodes at this level can comprise a virtual representation of a cluster nodes in the abstract graph.

Using GNNs, the nodes' embeddings can be obtained, which can be used for the network wide decision making (or policy adjustment) of rApps.

Control commands for policy adjustments can then be passed down to xApps or modules in a centralized unit (CU)/distributed unit (DU)/radio unit (RU).

At a near real-time RIC, the abstract graph can be constructed using the pooled information from the original graph at the previous level (e.g., the abstract graph can be a coarser version of the original graph).

A pooling operation can be chosen to be differentiable and permutation invariant. The graph at this level can be a heterogenous graph.

The nodes can comprise a virtual representation of a cluster of nodes in the original graph.

Using GNN^{a} nodes' embeddings can be obtained. These embeddings can be used:
For RIC level decision making by xApps at the near real-time;
For pooling to construct the super graph at the non-RT RIC.

At a lowest level, the input network can be represented as an original graph (either homogenous or heterogenous). The nodes at this level can be CUs, DUs and/or RUs.

Using GNN^{o} the nodes' embeddings at the local level (edge) can be obtained. These embeddings can be used:
For local and real-time decision making (together with policies from xApps/rApps);
For pooling to construct the abstract graph at the near real-time RIC.

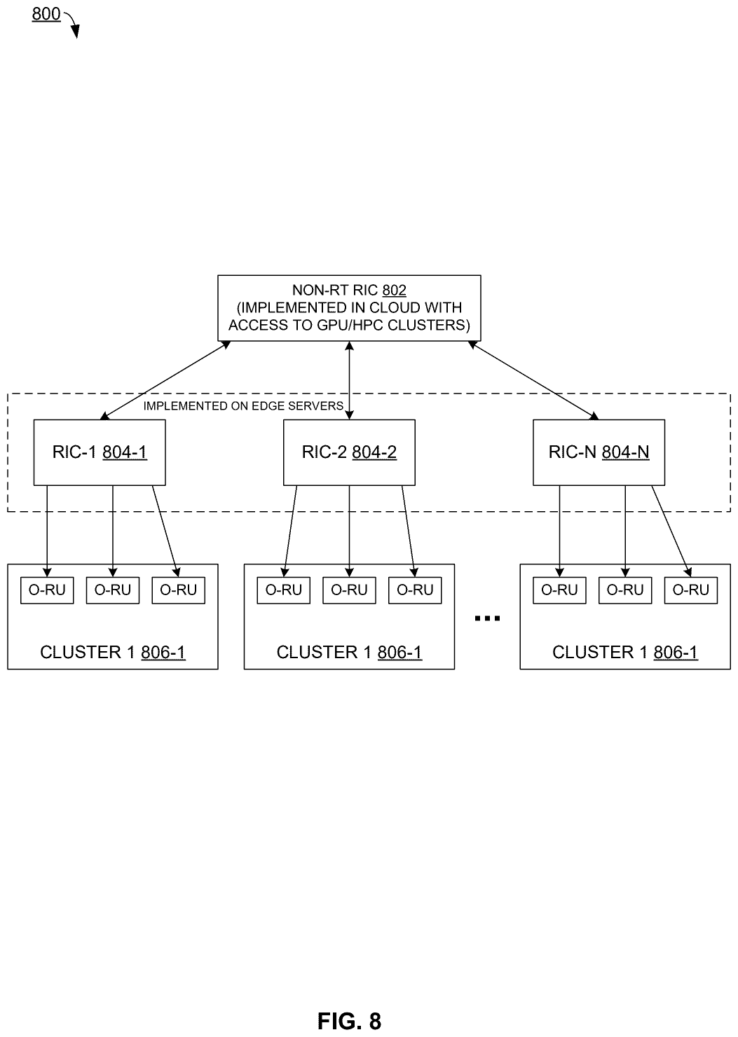

FIG. 8 illustrates an example 800 of federated learning that is facilitated by hierarchical graph representation for network management, in accordance with an embodiment of this disclosure. In some examples, part(s) of example 800 can be used by part(s) of system architecture 100 of FIG. 1 that is facilitated by hierarchical graph representation for network management.

Example 800 comprises non-RT RIC 802 (implemented in cloud with access to graphics processing unit (GPU)/high performance computing (HPC) clusters), RIC-1 804-1, RIC-2 804-2, RIC-N 804-N (where the RICs can be implemented on edge servers), cluster 1 806-1, cluster-2 806-2, and cluster N 806-N.

FIG. 8 illustrates use of a two-tiered model to achieve a network optimization. where the network policy recommendation engines reside within a RIC and make use of data the from the DUs and RUs at a lower level.

Learning (and optimization) can occur in two phases whereby local learning can occur at a near-RT RIC, and a reduced set of parameters with high fidelity can be transferred to a non-RT RIC, such as periodically or when polled to update a global model at the non-RT RIC.

Hierarchical federated learning (HFL) can be mapped to the super-graph architecture for efficient global learning that can also be privacy-reserving and to reduce data transfer bandwidth.

Benefits of these techniques can include:
A HFL approach can help train a model faster, and improve a communication versus computation trade-off.
A global model can be maintained by a cloud-hosted controller, (e.g., a non-RT RIC), and local models can be maintained at edge servers that provide both upstream information to a cloud based non-RT RIC and receive downstream model updates from it. This can help minimize a level of computationally intensive training that needs to be performed at the edge servers.

Such a hierarchical architecture can facilitate edge servers in downloading a global model periodically, perform a faster (multiple-)epoch-based local training, and then transfer only the model weights to the cloud server for model aggregation.

Since the network conditions can be dynamic, training in this manner can be continued at a pre-determined frequency which can be higher when the model is just deployed, and the update rate can subsequently be reduced to an equilibrium rate for a mature model to match with a rate of change of the network topology, etc.

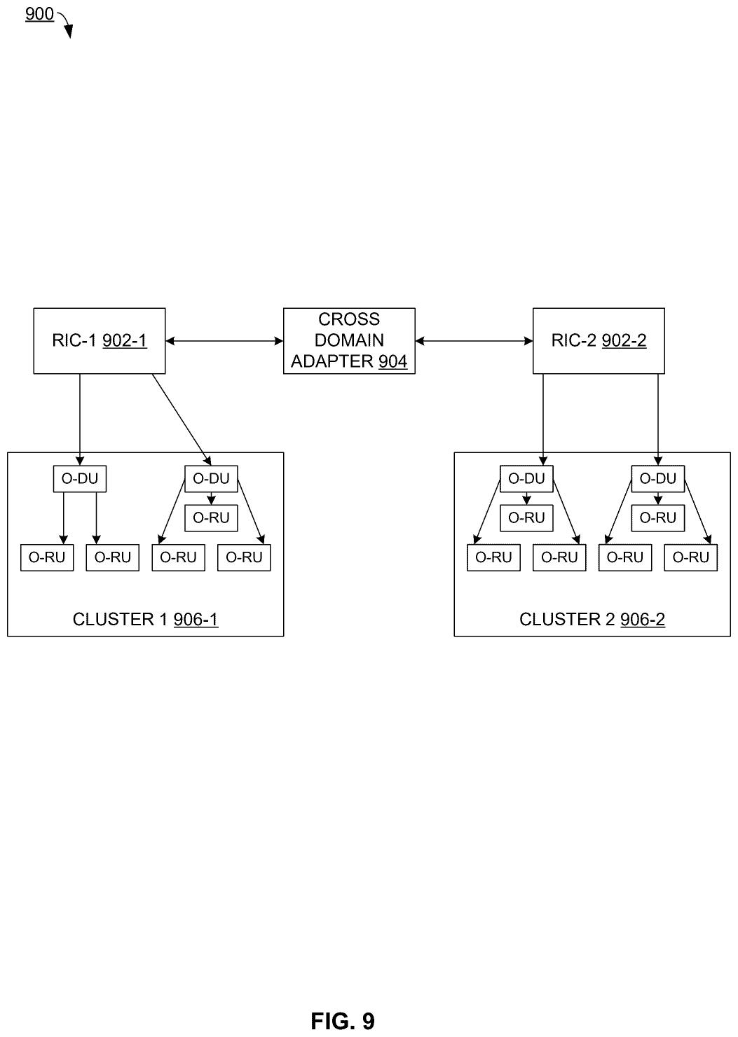

FIG. 9 illustrates an example 900 of inter-cluster transfer learning that is facilitated by hierarchical graph representation for network management, in accordance with an embodiment of this disclosure. In some examples, part(s) of example 900 can be used by part(s) of system architecture 100 of FIG. 1 that is facilitated by hierarchical graph representation for network management.

Example 900 comprises RIC-1 902-1, RIC-2 902-2, cross domain adapter 904, cluster 1 906-1, and cluster 2 906-2.

When a cell site is initialized, it can take time to collect enough data to train a NN-based model from scratch. Convergence of a ML model can take longer than usual, especially when data is sourced from multiple telemetry sites (e.g., RUs), which can occur in some examples.

It can be that, while no two cluster of cell-sites may have exact same behavior, there can be significant similarities and therefore transfer learning can be an effective approach, whereby a hierarchical graph learning approach according to the present techniques can be very effective.

In FIG. 9, there are different clusters, where one RIC assimilates data from multiple DUs, which in turn collect data from multiple RUs that are connected to them.

In this example, RIC-1 is the one that is operational, and RIC-2 is the one that is being initialized. A cross domain adapter can use transformations to initialize the NNs for RIC-2 although the topology of the sub-network managed by it is markedly different from that of RIC-1.

Processing for the shown varied sub-graphs/local clusters can be addressed according to the present techniques using a graph formation and operational steps using local enrichment information of RIC-2 and the DUs and RUs connected to it.

### Example Process Flows

FIG. 10 illustrates an example process flow 1000 for hierarchical graph representation for network management, in accordance with an embodiment of this disclosure. In some examples, one or more embodiments of process flow 1000 can be implemented by system architecture 100 of FIG. 1, or computing environment 1300 of FIG. 13.

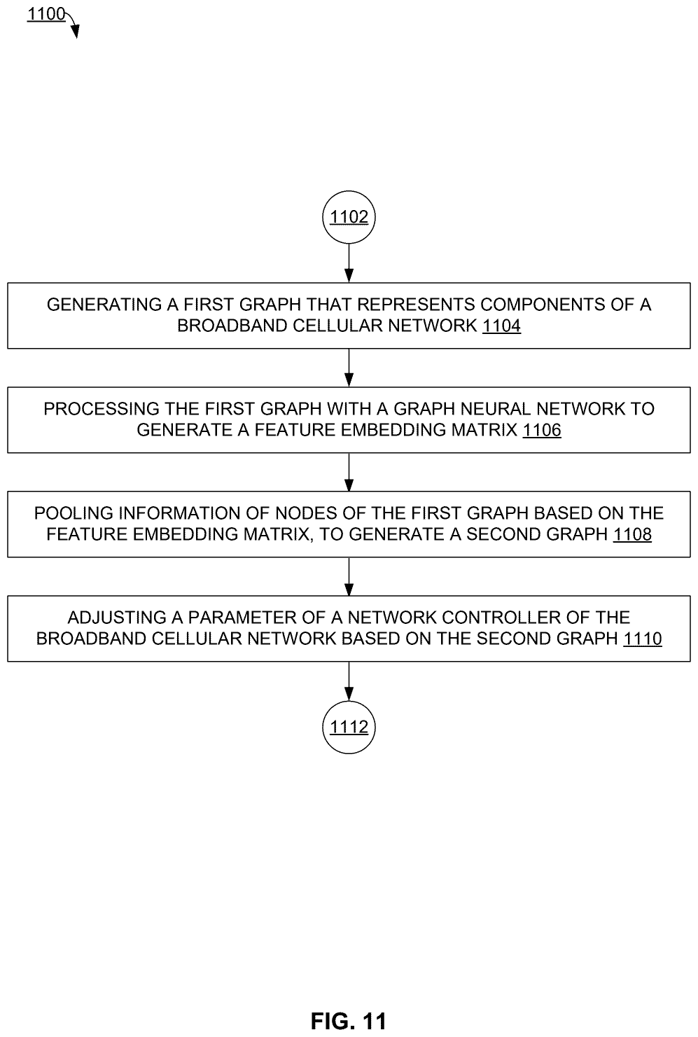

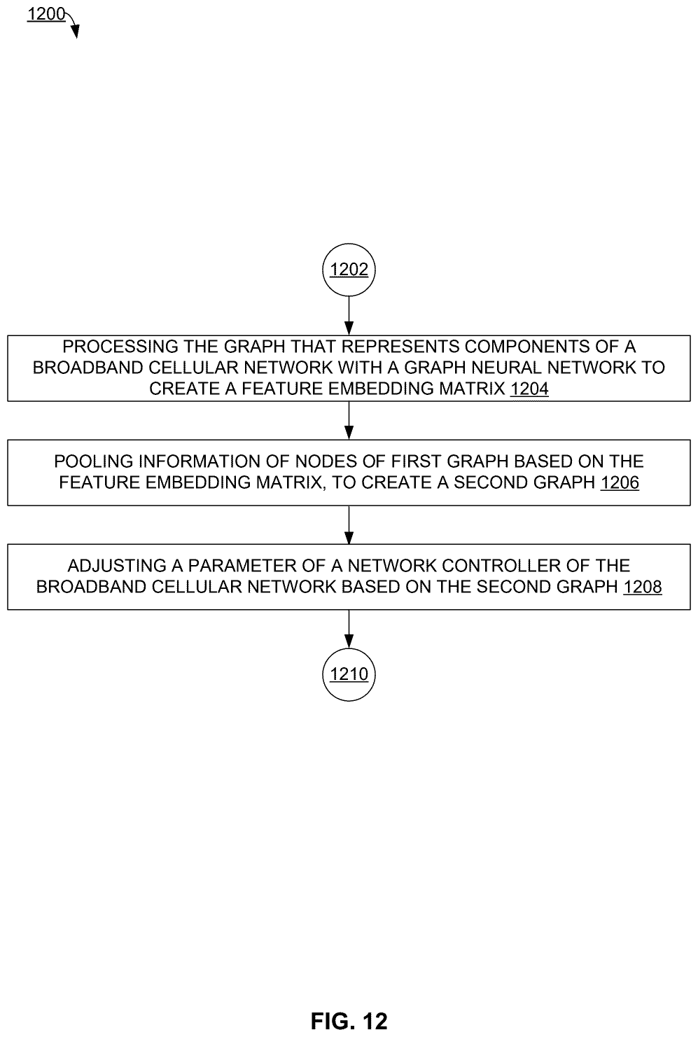

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of one or more of process flow 1100 of FIG. 11, and/or process flow 1200 of FIG. 12.

Process flow 1000 begins with 1002, and moves to operation 1004.

Operation 1004 depicts producing a first graph that represents components of a broadband cellular network, wherein the first graph comprises first nodes and first edges. The first graph can be an original graph as described herein.

In some examples, respective first nodes of the first nodes correspond to a centralized unit, a distributed unit, or a radio unit. That is, in an original graph, nodes can represent CUs, DUs, and/or RUs.

In some examples, respective first edges of the first edges correspond to respective communications between respective components of the components that are represented by respective first nodes of the first nodes. That is, messages passed across interfaces can be mapped to information passed along edges of a hierarchical graph.

After operation 1004, process flow 1000 moves to operation 1006.

Operation 1006 depicts processing the first graph with a graph neural network to produce a feature embedding matrix. That is, a GNN can be applied to an original graph to produce a feature embedding matrix.

After operation 1006, process flow 1000 moves to operation 1008.

Operation 1008 depicts pooling information of nodes of the first graph based on the feature embedding matrix, to produce a second graph, wherein the second graph comprises second nodes and second edges. That is, information of the nodes of the original graph can be pooled to produce an abstract graph, which can be the second graph here.

After operation 1008, process flow 1000 moves to operation 1010.

Operation 1010 depicts adjusting a parameter of a network controller of the broadband cellular network based on the second graph. That is, the abstract graph can be used to control near-RT operations.

That is, a parameter (or set of parameters) associated with either network elements or transmission parameters (to best take advantage of the network conditions for example) can be modified.

In some examples, adjusting the parameter comprises adjusting operation of near-real time operation of the broadband cellular network. For example, an abstract graph can be used to control the actions of an xApp.

In some examples, adjusting the parameter is performed based on the second graph and based on the first graph. That is, using a hierarchical GNN architecture, decision-making at higher levels (e.g., RIC) can consider the hierarchical structure of the network.

In some examples, the graph neural network is a first graph neural network, the feature embedding matrix is a first feature embedding matrix, the information is first information, the parameter is a first parameter, and operation 1010 comprises processing the second graph with a second graph neural network to produce a second feature embedding matrix; pooling second information the second nodes of the second graph based on the second feature embedding matrix, to produce a third graph; and adjusting a second parameter at a second layer of a non-real time radio access network intelligent controller based on the third graph, wherein the first parameter corresponds to a first layer of the broadband cellular network. That is, the third graph can be a super graph as described herein.

In some examples, adjusting the second parameter comprises adjusting a policy of network operation based on an optimization carried out within a network control module of the broadband cellular network. For example, a super graph can be used to control an rApp.

After operation 1010, process flow 1000 moves to 1012, where process flow 1000 ends.

FIG. 11 illustrates an example process flow 1100 for hierarchical graph representation for network management, in accordance with an embodiment of this disclosure. In some examples, one or more embodiments of process flow 1100 can be implemented by system architecture 100 of FIG. 1, or computing environment 1300 of FIG. 13.

It can be appreciated that the operating procedures of process flow 1100 are example operating procedures, and that there can be embodiments that implement more or fewer operating procedures than are depicted, or that implement the depicted operating procedures in a different order than as depicted. In some examples, process flow 1100 can be implemented in conjunction with one or more embodiments of one or more of process flow 1000 of FIG. 10, and/or process flow 1200 of FIG. 12.

Process flow 1100 begins with 1102, and moves to operation 1104.

Operation 1104 depicts generating a first graph that represents components of a broadband cellular network. In some examples, operation 1104 can be implemented in a similar manner as operation 1004 of FIG. 10.

After operation 1104, process flow 1100 moves to operation 1106.

Operation 1106 depicts processing the first graph with a graph neural network to generate a feature embedding matrix. In some examples, operation 1106 can be implemented in a similar manner as operation 1006 of FIG. 10.

In some examples, the graph neural network is a first graph neural network, and the generating of the first graph is performed with a second graph neural network. That is, a GNN can be used to create the original graph, and this GNN can be different from a GNN used to create an abstract graph.

After operation 1106, process flow 1100 moves to operation 1108.

Operation 1108 depicts pooling information of nodes of the first graph based on the feature embedding matrix, to generate a second graph. In some examples, operation 1108 can be implemented in a similar manner as operation 1008 of FIG. 10.

In some examples, the pooling of the information of the nodes of the first graph based on the feature embedding matrix comprises performing a softmax operation on the feature embedding matrix. This can be similar to S^{o}=Softmax(Z^{o}).

In some examples, the pooling is differentiable and permutation invariant.

After operation 1108, process flow 1100 moves to operation 1110.

Operation 1110 depicts adjusting a parameter of a network controller of the broadband cellular network based on the second graph. In some examples, operation 1110 can be implemented in a similar manner as operation 1010 of FIG. 10.

In some examples, the graph neural network is a first graph neural network, the feature embedding matrix is a first feature embedding matrix, the parameter is a first parameter, and operation 1010 comprises processing the second graph with a second graph neural network to generate a second feature embedding matrix, pooling information of second nodes of the second graph based on the second feature embedding matrix, to generate a third graph, and adjusting a second parameter of the broadband cellular network based on the third graph. That is, a super graph can be created and used.

In some examples, operation 1010 comprises making a decision regarding operation of the broadband cellular network based on the third graph, and relaying the decision to the first graph or the second graph for implementation of the decision on the broadband cellular network.

The execution of adjusting a cellular network can be performed at a CU, DU, or RU level, which can be represented in an original graph. Information can be pooled together (via graph processing) and sent to upper graph layers, which can operate on slower timescales. Information at an upper level can come from multiple sub-graphs. A decision made at this upper layer can be sent back down to a lower layer for execution, or to enhance decision making at the lower level. It can be that decision making at a lower layer is made at a fast time scale compared to an upper layer. This information from the upper layer to a lower layer can aid the lower layer in making a decision, where the lower layer could otherwise lack a global view of a network.

It can be that relaying a decision from a super graph to an original graph omits the abstract graph, but goes directly to a lowest level without going through the abstract graph.

The graphs can comprise representations of a network at different levels, or time scales. They can be used to pool information from a lower level to an upper level in an efficient manner to aid decision making.

In some examples, the making of the decision is performed based on multiple sub-graphs of the third graph.

After operation 1110, process flow 1100 moves to 1112, where process flow 1100 ends.

FIG. 12 illustrates an example process flow 1200 for hierarchical graph representation for network management, in accordance with an embodiment of this disclosure. In some examples, one or more embodiments of process flow 1200 can be implemented by system architecture 100 of FIG. 1, or computing environment 1300 of FIG. 13.

It can be appreciated that the operating procedures of process flow 1200 are example operating procedures, and that there can be embodiments that implement more or fewer operating procedures than are depicted, or that implement the depicted operating procedures in a different order than as depicted. In some examples, process flow 1200 can be implemented in conjunction with one or more embodiments of one or more of process flow 1000 of FIG. 10, and/or process flow 1100 of FIG. 11.

Process flow 1200 begins with 1202, and moves to operation 1204.

Operation 1204 depicts processing the graph that represents components of a broadband cellular network with a graph neural network to create a feature embedding matrix. In some examples, operation 1204 can be implemented in a similar manner as operations 1004-1006 of FIG. 10.

In some examples, the broadband cellular network comprises a multi-level network. That is, the present techniques can be implemented to facilitate a generic way to represent multi-level network optimization architectures in the form of graphical abstraction, and subsequently use deep neural networks (DNNs) to model the relationships between the nodes and derive optimal (or satisfactory) configurations.

After operation 1204, process flow 1200 moves to operation 1206.

Operation 1206 depicts pooling information of nodes of a first graph based on the feature embedding matrix, to create a second graph. In some examples, operation 1206 can be implemented in a similar manner as operation 1008 of FIG. 10.

After operation 1206, process flow 1200 moves to operation 1208.

Operation 1208 depicts adjusting a parameter of a network controller of the broadband cellular network based on the second graph. In some examples, operation 1208 can be implemented in a similar manner as operation 1010 of FIG. 10.

In some examples, the graph neural network is a first graph neural network, the feature embedding matrix is a first feature embedding matrix, the parameter is a first parameter, operation 1208 comprises processing the second graph with a second graph neural network to create a second feature embedding matrix, and pooling information of the nodes of the second graph based on the second feature embedding matrix, to create a third graph. In some examples, operation 1208 comprises adjusting a second parameter of the broadband cellular network based on the third graph. This third graph can be a super graph as described herein.

In some examples, operation 1208 comprises performing federated learning for the broadband cellular network based on the third graph. That is, a super graph can play a role of a collection of centralized nodes, such as in a case of federated learning.

In some examples, the broadband cellular network is a first broadband cellular network, operation 1208 comprises performing transfer learning from the first broadband cellular network to a second broadband cellular network based on the third graph satisfying a spatial correlation criterion or a semantic correlation criterion with a graph representation of the second broadband cellular network. In some examples, the present techniques can be implemented to use information transfer between nodes that are not fully connected but an have spatial and/or semantic correlation to leverage transfer learning with domain adaptation over the graph structure to reduce learning time for greenfield networks.

After operation 1208, process flow 1200 moves to 1210, where process flow 1200 ends.

### Example Operating Environment

In order to provide additional context for various embodiments described herein, FIG. 13 and the following discussion are intended to provide a brief, general description of a suitable computing environment 1300 in which the various embodiments of the embodiment described herein can be implemented.

For example, parts of computing environment 1300 can be used to implement one or more embodiments of computer 102 and/or cellular network 106 of FIG. 1.

In some examples, computing environment 1300 can implement one or more embodiments of the process flows of FIGS. 10-12 such that they are facilitated by hierarchical graph representation for network management.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per sc.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 13, the example environment 1300 for implementing various embodiments described herein includes a computer 1302, the computer 1302 including a processing unit 1304, a system memory 1306 and a system bus 1308. The system bus 1308 couples system components including, but not limited to, the system memory 1306 to the processing unit 1304. The processing unit 1304 can be any of various commercially available processors. Dual microprocessors and other multi-processor architectures can also be employed as the processing unit 1304.

The system bus 1308 can be any of several types of bus structure that can further interconnect to a memory bus (with or without a memory controller), a peripheral bus, and a local bus using any of a variety of commercially available bus architectures. The system memory 1306 includes ROM 1310 and RAM 1312. A basic input/output system (BIOS) can be stored in a nonvolatile storage such as ROM, erasable programmable read only memory (EPROM), EEPROM, which BIOS contains the basic routines that help to transfer information between elements within the computer 1302, such as during startup. The RAM 1312 can also include a high-speed RAM such as static RAM for caching data.

The computer 1302 further includes an internal hard disk drive (HDD) 1314 (e.g., EIDE, SATA), one or more external storage devices 1316 (e.g., a magnetic floppy disk drive (FDD) 1316, a memory stick or flash drive reader, a memory card reader, etc.) and an optical disk drive 1320 (e.g., which can read or write from a CD-ROM disc, a DVD, a BD, etc.). While the internal HDD 1314 is illustrated as located within the computer 1302, the internal HDD 1314 can also be configured for external use in a suitable chassis (not shown). Additionally, while not shown in environment 1300, a solid state drive (SSD) could be used in addition to, or in place of, an HDD 1314. The HDD 1314, external storage device(s) 1316 and optical disk drive 1320 can be connected to the system bus 1308 by an HDD interface 1324, an external storage interface 1326 and an optical drive interface 1328, respectively. The interface 1324 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1302, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1312, including an operating system 1330, one or more application programs 1332, other program modules 1334 and program data 1336. All or portions of the operating system, applications, modules, and/or data can also be cached in the RAM 1312. The systems and methods described herein can be implemented utilizing various commercially available operating systems or combinations of operating systems.

Computer 1302 can optionally comprise emulation technologies. For example, a hypervisor (not shown) or other intermediary can emulate a hardware environment for operating system 1330, and the emulated hardware can optionally be different from the hardware illustrated in FIG. 13. In such an embodiment, operating system 1330 can comprise one virtual machine (VM) of multiple VMs hosted at computer 1302. Furthermore, operating system 1330 can provide runtime environments, such as the Java runtime environment or the .NET framework, for applications 1332. Runtime environments are consistent execution environments that allow applications 1332 to run on any operating system that includes the runtime environment. Similarly, operating system 1330 can support containers, and applications 1332 can be in the form of containers, which are lightweight, standalone, executable packages of software that include, e.g., code, runtime, system tools, system libraries and settings for an application.

Further, computer 1302 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1302, e.g., applied at the application execution level or at the operating system (OS) kernel level, thereby enabling security at any level of code execution.

A user can enter commands and information into the computer 1302 through one or more wired/wireless input devices, e.g., a keyboard 1338, a touch screen 1340, and a pointing device, such as a mouse 1342. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1304 through an input device interface 1344 that can be coupled to the system bus 1308, but can be connected by other interfaces, such as a parallel port, an IEEE 1394 serial port, a game port, a USB port, an IR interface, a BLUETOOTH® interface, etc.

A monitor 1346 or other type of display device can be also connected to the system bus 1308 via an interface, such as a video adapter 1348. In addition to the monitor 1346, a computer typically includes other peripheral output devices (not shown), such as speakers, printers, etc.

The computer 1302 can operate in a networked environment using logical connections via wired and/or wireless communications to one or more remote computers, such as a remote computer(s) 1350. The remote computer(s) 1350 can be a workstation, a server computer, a router, a personal computer, portable computer, microprocessor-based entertainment appliance, a peer device or other common network node, and typically includes many or all of the elements described relative to the computer 1302, although, for purposes of brevity, only a memory/storage device 1352 is illustrated. The logical connections depicted include wired/wireless connectivity to a local area network (LAN) 1354 and/or larger networks, e.g., a wide area network (WAN) 1356. Such LAN and WAN networking environments are commonplace in offices and companies, and facilitate enterprise-wide computer networks, such as intranets, all of which can connect to a global communications network, e.g., the Internet.

When used in a LAN networking environment, the computer 1302 can be connected to the local network 1354 through a wired and/or wireless communication network interface or adapter 1358. The adapter 1358 can facilitate wired or wireless communication to the LAN 1354, which can also include a wireless access point (AP) disposed thereon for communicating with the adapter 1358 in a wireless mode.

When used in a WAN networking environment, the computer 1302 can include a modem 1360 or can be connected to a communications server on the WAN 1356 via other means for establishing communications over the WAN 1356, such as by way of the Internet. The modem 1360, which can be internal or external and a wired or wireless device, can be connected to the system bus 1308 via the input device interface 1344. In a networked environment, program modules depicted relative to the computer 1302 or portions thereof, can be stored in the remote memory/storage device 1352. It will be appreciated that the network connections shown are examples, and other means of establishing a communications link between the computers can be used.

When used in either a LAN or WAN networking environment, the computer 1302 can access cloud storage systems or other network-based storage systems in addition to, or in place of, external storage devices 1316 as described above. Generally, a connection between the computer 1302 and a cloud storage system can be established over a LAN 1354 or WAN 1356 e.g., by the adapter 1358 or modem 1360, respectively. Upon connecting the computer 1302 to an associated cloud storage system, the external storage interface 1326 can, with the aid of the adapter 1358 and/or modem 1360, manage storage provided by the cloud storage system as it would other types of external storage. For instance, the external storage interface 1316 can be configured to provide access to cloud storage sources as if those sources were physically connected to the computer 1302.

The computer 1302 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### Conclusion

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
producing a first graph that represents components of a broadband cellular network, wherein the first graph comprises first nodes and first edges;
processing the first graph with a graph neural network to produce a feature embedding matrix;
pooling information of nodes of the first graph based on the feature embedding matrix, to produce a second graph, wherein the second graph comprises second nodes and second edges; and
adjusting a parameter of a network controller of the broadband cellular network based on the second graph.

2. The system of claim 1, wherein the graph neural network is a first graph neural network, wherein the feature embedding matrix is a first feature embedding matrix, wherein the information is first information, wherein the parameter is a first parameter, and wherein the operations further comprise:
processing the second graph with a second graph neural network to produce a second feature embedding matrix;
pooling second information the second nodes of the second graph based on the second feature embedding matrix, to produce a third graph; and
adjusting a second parameter at a second layer of the broadband cellular network based on the third graph, wherein the first parameter corresponds to a first layer of the broadband cellular network.

3. The system of claim 2, wherein adjusting the second parameter comprises adjusting a policy of network operation based on an optimization carried out within a network control module of the broadband cellular network.

4. The system of claim 1, wherein adjusting the parameter comprises adjusting operation of near-real time operation of the broadband cellular network.

5. The system of claim 1, wherein respective first nodes of the first nodes correspond to a centralized unit, a distributed unit, or a radio unit.

6. The system of claim 1, wherein respective first edges of the first edges correspond to respective communications between respective components of the components that are represented by respective first nodes of the first nodes.

7. The system of claim 1, wherein adjusting the parameter is performed based on the second graph and based on the first graph.

8. A method, comprising:
generating, by a system comprising at least one processor, a first graph that represents components of a broadband cellular network;
processing, by the system, the first graph with a graph neural network to generate a feature embedding matrix;
pooling, by the system, information of nodes of the first graph based on the feature embedding matrix, to generate a second graph; and
adjusting, by the system, a parameter of a network controller of the broadband cellular network based on the second graph.

9. The method of claim 8, wherein the graph neural network is a first graph neural network, wherein the feature embedding matrix is a first feature embedding matrix, wherein the parameter is a first parameter, and further comprising:
processing, by the system, the second graph with a second graph neural network to generate a second feature embedding matrix;
pooling, by the system, information of second nodes of the second graph based on the second feature embedding matrix, to generate a third graph; and
adjusting, by the system, a second parameter of the broadband cellular network based on the third graph.

10. The method of claim 8, wherein the pooling of the information of the nodes of the first graph based on the feature embedding matrix comprises:
performing a softmax operation on the feature embedding matrix.

11. The method of claim 8, wherein the graph neural network is a first graph neural network, and wherein the generating of the first graph is performed with a second graph neural network.

12. The method of claim 8, wherein the pooling is differentiable and permutation invariant.

13. The method of claim 9, further comprising:
making, by the system, a decision regarding operation of the broadband cellular network based on the third graph; and
relaying, by the system, the decision to the first graph or the second graph for implementation of the decision on the broadband cellular network.

14. The method of claim 13, wherein the making of the decision is performed based on multiple sub-graphs of the third graph.

15. A non-transitory computer-readable medium comprising instructions that, in response to execution, cause a system comprising at least one processor to perform operations, comprising:
processing the graph that represents components of a broadband cellular network with a graph neural network to create a feature embedding matrix;
pooling information of nodes of first graph based on the feature embedding matrix, to create a second graph; and
adjusting a parameter of a network controller of the broadband cellular network based on the second graph.

16. The non-transitory computer-readable medium of claim 15, wherein the graph neural network is a first graph neural network, wherein the feature embedding matrix is a first feature embedding matrix, wherein the parameter is a first parameter, and wherein the operations further comprise:
processing the second graph with a second graph neural network to create a second feature embedding matrix; and
pooling information of the nodes of the second graph based on the second feature embedding matrix, to create a third graph.

17. The non-transitory computer-readable medium of claim 16, wherein the operations further comprise:
adjusting a second parameter of the broadband cellular network based on the third graph.

18. The non-transitory computer-readable medium of claim 16, wherein the operations further comprise:
performing federated learning for the broadband cellular network based on the third graph.

19. The non-transitory computer-readable medium of claim 16, wherein the broadband cellular network is a first broadband cellular network, and wherein the operations further comprise:
performing transfer learning from the first broadband cellular network to a second broadband cellular network based on the third graph satisfying a spatial correlation criterion or a semantic correlation criterion with a graph representation of the second broadband cellular network.

20. The non-transitory computer-readable medium of claim 15, wherein the broadband cellular network comprises a multi-level network.
